(19) United States
(12) Patent Application Publication
(10) Pub. No.: US 2018/0184637 A1
(43) Pub. Date: Jul. 5, 2018

(54) SYSTEM, METHOD AND COMPUTER PROGRAM PRODUCT FOR LOCUST SWARM AMELIORATION

(71) Applicant: International Business Machines Corporation, Armonk, NY (US)

(72) Inventors: Thomas D. Erickson, Minneapolis, MN (US); Clifford A. Pickover, Yorktown Heights, NY (US); Maja Vukovic, New York, NY (US); Komminist Weldemariam, Nairobi (KE)

(73) Assignee: International Business Machines Corporation

(21) Appl. No.: 15/396,908

(22) Filed: Jan. 3, 2017

(51) Int. Cl. A01M 7/00; B64D 1/18; B64C 39/02; G05D 1/00; A01M 13/00; G06N 3/12; G06N 7/00; G06N 99/00

(52) U.S. Cl. CPC A01M 7/005; B64D 1/18; B64C 39/024; G05D 1/0016; B64C 2201/12; G06N 3/126; G06N 7/005; G06N 99/005; B64C 2201/146; A01M 13/00

(57) ABSTRACT

A locust swarm amelioration method, system, and computer program product, includes detecting a locust swarm either about to form, or having formed, and controlling a drone to perform an amelioration action against the locust swarm about to form or having been formed.

### BACKGROUND

The present invention relates generally to a locust swarm amelioration method, and more particularly, but not by way of limitation, to a system, method, and computer program product for detecting either a formed locust swarm, or a locust swarm being formed, to thereby take an amelioration action against the locust swarm.

Swarming behavior of locusts is a response to overcrowding. Increased tactile stimulation of the hind legs causes an increase in levels of serotonin. This causes the locust to change color, eat much more, and breed much more easily. The transformation of the locust to the swarming form is induced by several contacts per minute over an hour period. Under certain conditions, solitary locusts can transform to a gregarious form (i.e., a so-called “sociable” form) and coalesce into swarms. Swarms can consume hectares of vegetation in a few days, ultimately causing billions of dollars of damage to the food supply chains.

### SUMMARY

In an exemplary embodiment, the present invention can provide a computer-implemented method including detecting a locust swarm either about to form, or having formed, and controlling a drone to perform an amelioration action against the locust swarm about to form or having been formed.

One or more other exemplary embodiments include a computer program product and a system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a locust swarm amelioration method 100;

FIG. 2 depicts a cloud computing node according to an embodiment of the present invention;

FIG. 3 depicts a cloud computing environment according to an embodiment of the present invention; and

FIG. 4 depicts abstraction model layers according to an embodiment of the present invention.

### DETAILED DESCRIPTION

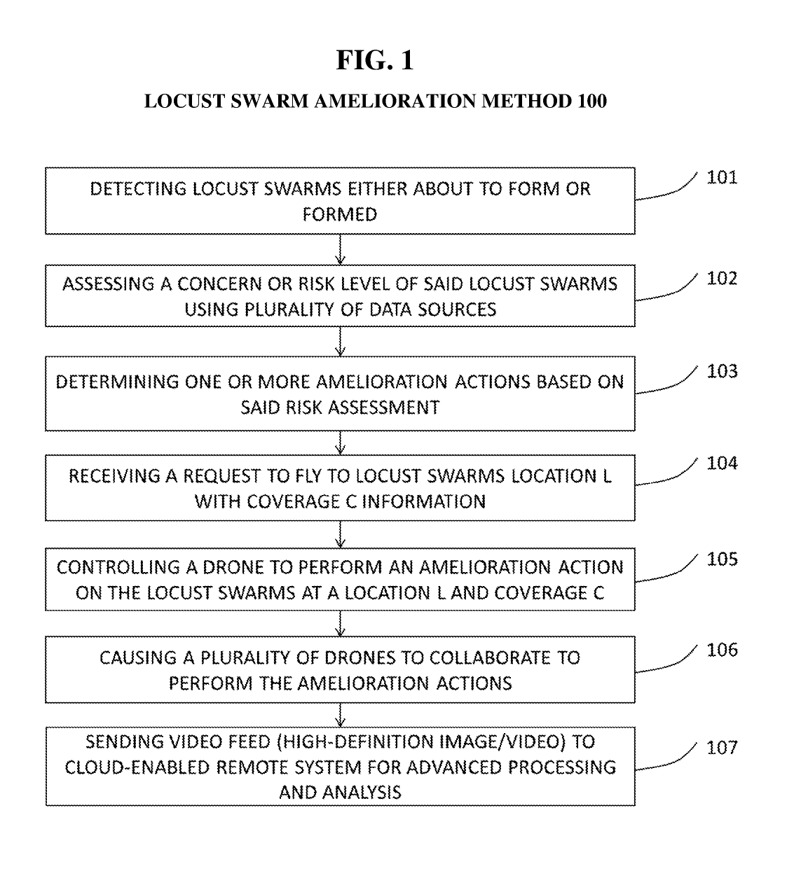

The invention will now be described with reference to FIG. 1-4, in which like reference numerals refer to like parts throughout. It is emphasized that, according to common practice, the various features of the drawing are not necessarily to scale. On the contrary, the dimensions of the various features can be arbitrarily expanded or reduced for clarity.

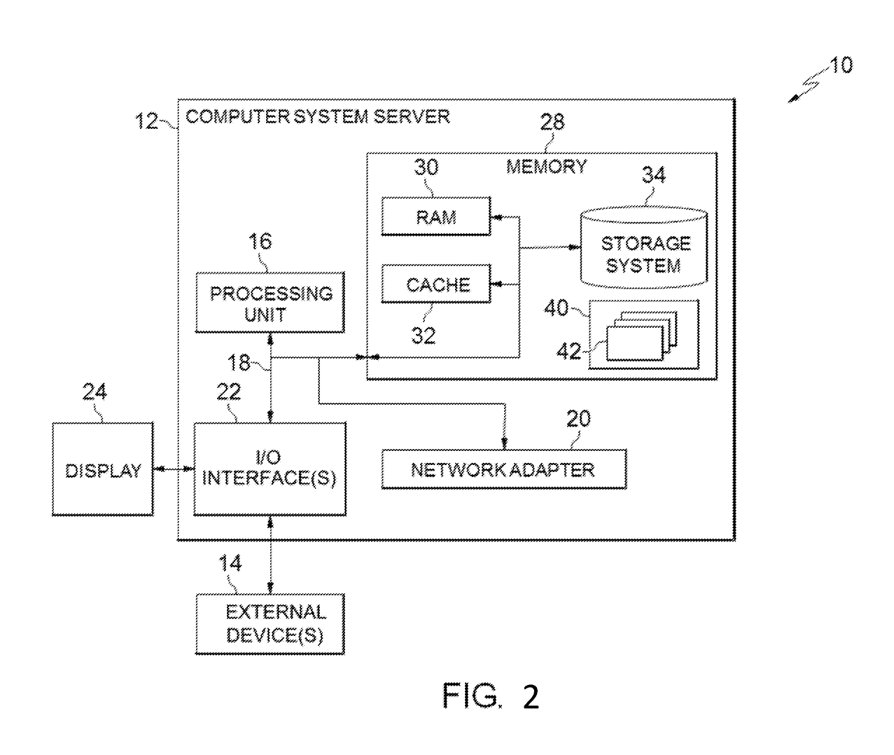

With reference now to the example depicted in FIG. 1, the locust swarm amelioration method 100 includes various steps to detect locust swarms and take amelioration actions against the locust swarms. As shown in at least FIG. 2, one or more computers of a computer system 12 according to an embodiment of the present invention can include a memory 28 having instructions stored in a storage system to perform the steps of FIG. 1.

Thus, the locust swarm amelioration method 100 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties—perception, goal-oriented behavior, learning/memory and action—that characterize systems (i.e., humans) generally recognized as cognitive.

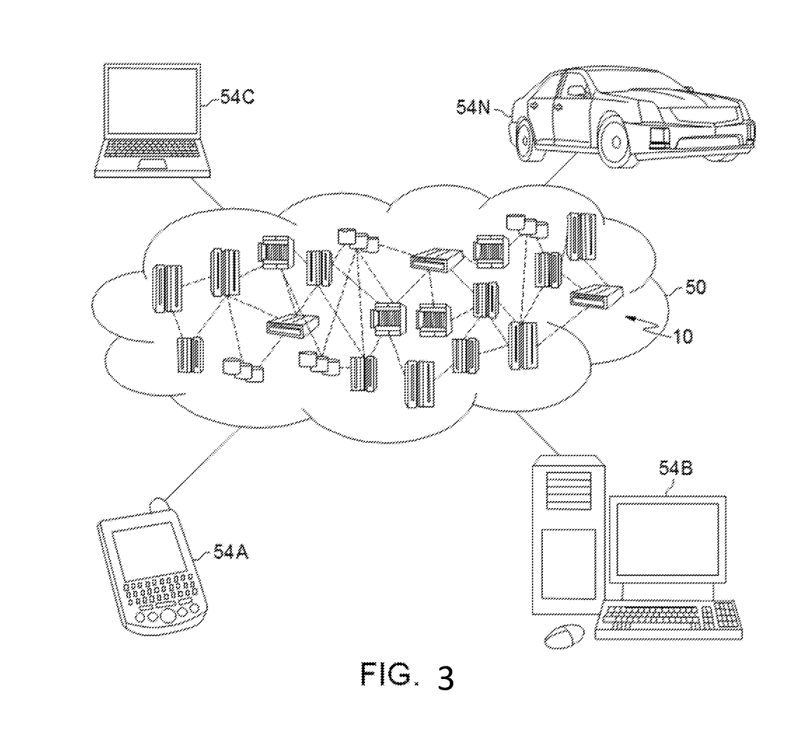

Although one or more embodiments (see e.g., FIGS. 2-4) may be implemented in a cloud environment 50 (see e.g., FIG. 3), it is nonetheless understood that the present invention can be implemented outside of the cloud environment.

It is noted that the description of the method 100 may utilize an autonomous flying drone (or swarm of drones), but the invention is not limited to drones. That is, any fixed wing aircraft can also perform the method and include the system and computer program product. The drone performing the method 100 includes various sensors to detect locust conditions. The drone performing the method 100 may include various risk analysis modules to compute expected concern, risk or damage that the locust swarm may cause (e.g., risk of destroying 20 hectares of rice farm in T time period). Many modifications and variations of the drones will be apparent to those of ordinary skill in the art without departing from the scope and spirit of the described embodiments.

In step 101, locust swarms either about to form, or already formed, are detected via the drone(s). That is, locusts transitioning to a gregarious form are detected via surveillance from the sensors, use of deep neural networks, pattern classifiers, etc., and swarms that are likely to form, or coalesce with other swarms, are detected.

In step 101, locust swarms forming, or about to form, may be detected based on, for example, learned or predicted context (e.g., forecasted weather patterns, rainfall patterns). That is, rainfall followed by a drought can trigger swarming as locusts are forced closer and closer together on smaller patches of remaining vegetation. The enforced mingling triggers the physical change from a solitary locust into a gregarious locust.

The locust swarms can also be detected in step 101 based on topography (e.g., bands move downhill) and wind direction (e.g., swarms generally move with the wind). The topography and wind direction can be used to determine directions in which bands and swarms are likely to move and thus whether they are likely to combine with other bands and swarms thereby increasing the speed and extent of transition into the gregarious form.

The locust swarms can further be detected in step 101 based on insect density and unstable solitary behavior of a locust. Alternatively, the drones can capture (e.g., examine) locusts and conduct an assay to analyze serotonin levels of the locusts onboard the drone.

In some embodiments, the drones can include a WiFi (or the like) connection such that social media or user data about locusts from locals can be directly input to factor in when detecting locust swarms. That is, in addition to drone-based detection using sensors on-board the drone, users (e.g., farmers, herdsmen, community network, etc.) can employ social media as part of the overall efforts in locust surveillance, monitoring, and reporting such that the swarms can be detected based on the uploaded information in step 101. Swarm breeding may take place in remote and difficult to access areas which are not normally patrolled by the drone(s). The user data can be used to detect the formation of locust swarms in the remote areas to stop the swarms from forming in these remote areas and subsequently moving quickly to more populous areas (e.g., locust swarms move quickly and destroy crops quickly).

In some embodiments, genetic algorithms may also be used to intelligently determine the rate of swarm formation, and, based on the rate, further amelioration actions may be triggered (e.g., increase the number of drones, request specialized drones, etc.).

In step 102, the drone-based system is equipped with risk assessment modules to compute concern, risk or damage that the locust swarm may cause (e.g., risk of destroying 20 hectares of rice farm in T time period). The risk assessment modules may use the rate of locust swarm formation, locust movement pattern, or use plurality of other data sources. Various statistical or machine learning algorithms may be used to compute the risk level.

In step 103, the drone-based system determines one or more amelioration actions based on said risk assessment and dynamic context information (e.g. weather forecast).

In step 104, the drone-based system may determine the optimal number of drones or drone swarm needed for the said one or more amelioration actions. The system then triggers the one or more drones to fly to locust swarm location L with coverage C information. The location L and coverage C information may dynamically change based on the locust swarms' movement patterns.

In step 105, the drone is controlled to perform an amelioration action on the detected locust swarm. The rate that locusts change to being solitary decreases with increasing population density and the rate of locusts changing to being sociable (i.e., gregarious) increases with increasing population density. The rates are monotonically decreasing and increasing, respectively. Thus, the amelioration action is performed to control the locust population to limit (e.g., eliminate) the locust swarms. It is noted that said risk assessment modules may use the computed rates to update risk level.

It is noted that, with the invention, the locust swarms are preferably diffused before the locust swarms form (e.g., detect the locust activity before the locust swarm forms in step 101). That is, controlling the drone to perform an amelioration action to control locust populations before they swarm is easier than controlling an active swarm as shown in FIG. 3. This controlling action may help to efficiently reduce the predicted risk, concern or damage level (in step 103) of the active smarms.

That is, the drone is controlled to execute preventive treatment, including treatments of naturally occurring, botanical pest control agents made from the neem tree or certain types of fungus. These kinds of organic pesticides offer many benefits, including how they specifically target locusts and their close relatives, safety for humans, environmental friendliness, and relatively longer-lasting effect. The drone may be equipped with sensors that will evaluate the pesticides ensuring the minimal impact on the environment. Machine learning algorithms may be employed to detect patterns in swarm behavior, types of treatment applied and outcomes, to further identify the most suitable treatment in a given context/situational setting (e.g., a severity of the amelioration action to perform).

In some embodiments, the amelioration action can include controlling the drone to emit a locust-killing agent such as fungal spores of a Metarhizium species which is sprayed via a high-pressure spraying device (or the like) mounted on the drone. For example, the drone can be controlled by a locust eradication information computer system and a wireless remote control navigation system (e.g., a control system) which may collaborate with a ground navigation command system that emits navigation instructions. If desired, a ground locust eradication combat command system emits locust eradication combat instructions. In other words, the drone can be a so-called “GPS-based unmanned aerial vehicle pesticide spraying device”. A central control module may store an operation prescription map, and the GPS signal receiver determines the position of an unmanned aerial vehicle, and transmits a signal of the position of the unmanned aerial vehicle to the central control module. The central control module obtains pesticide (or fungal spore) spraying information at the position of the unmanned aerial vehicle according to the operation prescription map and controls the sprayer to conduct locust killing-agent spraying. The locust-killing agent may be changed according to different varieties, different densities and other parameters of crops inside the agent spraying area, so that waste of the agent is reduced, the agent spraying accuracy is improved, the disinfection effect can be ensured, the agent residues can be well reduced, and the quality of agricultural products is improved.

In some embodiments, the drone can be controlled in step 102 to emit polarized light as the amelioration action. Polarized light generating devices can be mounted on the drone that may redirect locust swarms movement by deterring them. The redirection of their movement is toward fake or simulated vegetation lands such that drones can effectively execute preventive treatments.

In some embodiments, a variety of measures responsive to the radiation returns may be taken to eliminate the locusts. These measures may include firing pulses of beamed energy or radiation of a sufficient intensity to at least incapacitate them, or mechanical measures such as controlled drone aircraft to track and kill the pests.

In other embodiments, the amelioration action can include using precision positioning and vision technology of the drone to autonomously and precisely suppress the changing of solitary locusts to a swarming group. That is, the drones can be positioned to emit noise or positioned in such a way to cause locusts to divert a flight path to decrease the likelihood of the locust swarm forming.

In some embodiments, the amelioration action can include employing lasers, radar, and other types of radiation on the drone to illuminate at least a perimeter around assets to be protected (or for locusts on the ground about to convert to swarming behavior), with radiation returns detected and applied to a pattern classifier (e.g., based on one or more pattern recognition algorithms) to determine whether the detected insects and behavior are harmful or benign. The pattern recognition algorithms may be probabilistic in nature, in that the algorithms use statistical inferences to find the best label for a given instance. Probabilistic algorithms also output a probability of the instance being described by the given label. In addition, probabilistic algorithms output a list of the N-best labels with associated probabilities, for some value of N, instead of simply a single best label. When the number of possible labels is fairly small (e.g., in the case of classification), N may be set so that the probability of all possible labels is output. Because of the probabilities output, probabilistic pattern-recognition algorithms can be more effectively incorporated into larger machine-learning tasks, in a way that partially or completely avoids the problem of error propagation.

In step 106, a plurality of drones (e.g., a drone swarm) are caused to collaborate together to perform the amelioration action. That is, the movement and massiveness of locust swarms can be very dynamic. The drones can be caused to operate and collaborate in distributed manner (e.g., using global history hash table) such that data sharing and computation results (e.g., results from pattern classifier) of drones are easily accessible between the networks of drones.

In step 107, the drone may send video feed (high-definition image/video) to cloud-enabled remote system for advanced processing and analysis.

In further embodiment, based on the ongoing controlling activities by the drones, the system may present to remote users (e.g., professional, authorities, etc.) on GUIs (Graphical User Interfaces) and wherein the users may modify, control, interact or configure the processing and parameters or decision modules.

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 2, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 2, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 3, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 3 are intended to be illustrative only and that computing nodes 10 and cloud computing environment 50 can communicate with any type of computerized circuit over any type of network and/or network addressable connection (e.g., using a web browser).

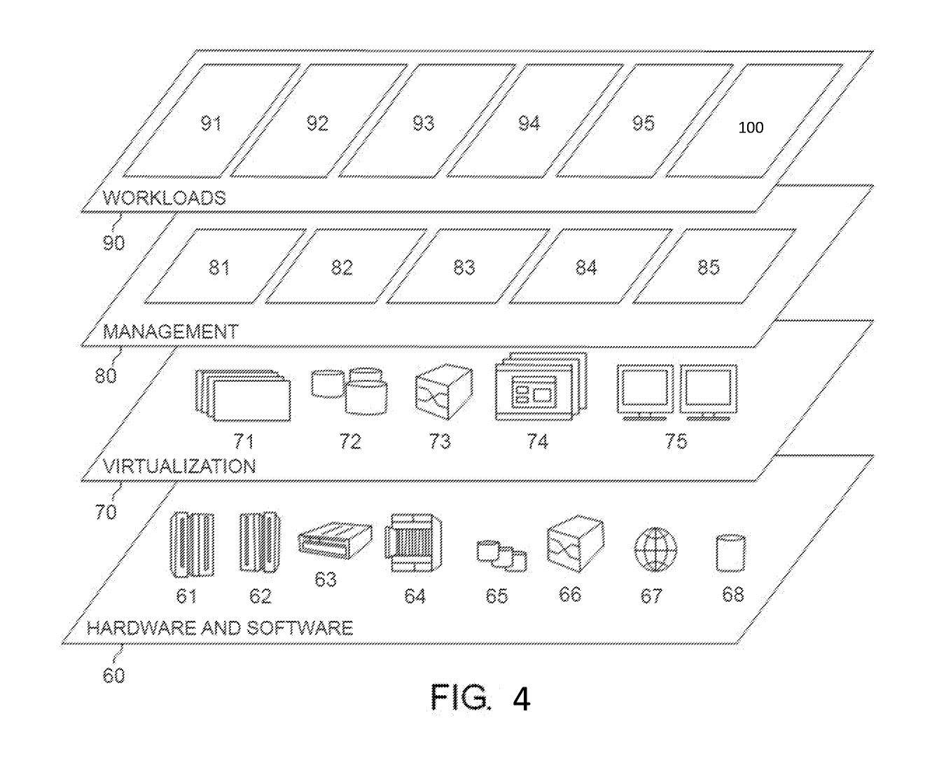

Referring now to FIG. 4, an exemplary set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the locust swarm amelioration method 100.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented locust swarm amelioration method, the method comprising:
detecting a locust swarm either about to form, or having formed; and
controlling a drone to perform an amelioration action against the locust swarm about to form or having been formed.

2. The computer-implemented method of claim 1, wherein the amelioration action is selected from the group consisting of:
causing an aerial sprayer on the drone to spray a locust swarm dispersant agent;
controlling the drone to emit a noise;
controlling the drone to release fungal spores sprayed in a breeding area of locust; and
controlling a flight path of the drone to increase a randomness that the locust swarm experiences.

3. The computer-implemented method of claim 1, wherein the detecting detects if the locust swarm is about to form or has formed based on rainfall patterns.

4. The computer-implemented method of claim 1, wherein the detecting detects if the locust swarm is about to form or has formed based on an insect density and an unstable solitary behavior.

5. The computer-implemented method of claim 1, wherein the amelioration action includes causing the drone to release a locust-killing agent.

6. The computer-implemented method of claim 5, wherein the locust-killing agent is selected based on different varieties, different densities and types of crops inside a spraying area.

7. The computer-implemented method of claim 1, wherein the amelioration action comprises the drone illuminating at least a perimeter around assets to be protected from the locust swarm with radiation returns detected and the radiation returns applied to a pattern classifier to determine whether the detected locust swarm and behavior are harmful.

8. The computer-implemented method of claim 1, wherein the amelioration action comprises controlling the drone to fire pulses of beamed energy or radiation of an intensity to disperse the locust swarm.

9. The computer-implemented method of claim 1, wherein the drone includes a polarized light generating device that is controlled by the controlled to redirect the locust swarm movement by deterring the locust swarm.

10. The computer-implemented method of claim 1, further comprising causing a plurality of drones to collaborate to each perform the amelioration action together.

11. The computer-implemented method of claim 1, wherein the detecting detects if the locust swarm is about to form or has formed using a genetic algorithm to intelligently determine a rate of swarm formation, and
wherein, based on the rate of formation, further amelioration actions are triggered.

12. The computer-implemented method of claim 1, wherein the detecting detects if the locust swarm is about to form or has formed based on a color of the locust.

13. The computer-implemented method of claim 1, wherein the amelioration action is generated based on a risk assessment and dynamic context information.

14. The computer-implemented method of claim 13, wherein the risk assessment comprises:
computing an expected concern, a risk or a damage that the locust swarm formed or about to form can cause using rates of locust swarm formation, locust movement pattern, and a plurality of data sources by employing a statistical or machine learning algorithms;
determining an optimal number of drones required for the amelioration action; and
triggering the drone to fly to a locust swarm location with coverage information,
wherein the location and the coverage information dynamically changes based on a locust swarms' movement patterns.

15. The system of claim 1, wherein a user controls the drones via a Graphical User Interface (GUI) on a remote control, and
wherein, using the GUIs, the user can modify, control, interact and configure the processing and parameters of the drones.

16. A computer program product for locust swarm amelioration, the computer program product comprising a computer readable storage medium having program instructions embodied therewith, the program instructions executable by a computer to cause the computer to perform:
detecting a locust swarm either about to form, or having formed; and
controlling a drone to perform an amelioration action against the locust swarm about to form or having been formed.

17. The computer program product of claim 16, wherein the amelioration action is selected from the group consisting of:
causing an aerial sprayer on the drone to spray a locust swarm dispersant agent;
controlling the drone to emit a noise;
controlling the drone to release fungal spores sprayed in a breeding area of locust; and
controlling a flight path of the drone to increase a randomness that the locust swarm experiences.

18. The computer-program product of claim 16, wherein the detecting detects if the locust swarm is about to form or has formed based on rainfall patterns.

19. A locust swarm amelioration system, said system comprising:
a processor; and
a memory, the memory storing instructions to cause the processor to:
detecting a locust swarm either about to form, or having formed; and
controlling a drone to perform an amelioration action against the locust swarm about to form or having been formed.

20. The system of claim 19, embodied in a cloud-computing environment.
